(19) United States
(12) Patent Application Publication
(10) Pub. No.: US 2015/0170237 A1
(43) Pub. Date: Jun. 18, 2015

(54) ARTICLE ANALYSIS AND EXCHANGE

(71) Applicant: Alexandra A. Powell, Wilton, CA (US)

(72) Inventor: Alexandra A. Powell, Wilton, CA (US)

(21) Appl. No.: 14/107,558

(22) Filed: Dec. 16, 2013

(51) Int. Cl. G06Q 30/06; G06Q 20/14; G06Q 30/00

(52) U.S. Cl. CPC G06Q 30/0611; G06Q 30/018; G06Q 20/14

(57) ABSTRACT

An article analysis and exchange system may be configured to accept an article, such as jewelry or other articles having valuable materials, and analyze the composition of the article via one or more elemental analysis technologies. The system may also be configured to verify the identity of the user. Based on the outcome of the elemental analysis, the system may then check the value of the detected material(s), weigh the article, and offer an amount of money to the user based on the composition of the article and the material(s) therein. If the offer is accepted, funds may be physically dispensed to the user and/or electronically transferred to an account designated by the user.

### FIELD

The present invention generally relates to analyzing and exchanging articles, and, more particularly, to systems and methods for that analyzing materials contained in articles and exchanging funds for the articles based on a value of the materials in the articles.

### BACKGROUND

Conventionally, to exchange valuable articles for currency, such as jewelry, the owner must go to a jewelry store, a pawn shop, a smelter, a gem wholesaler, or another location that specializes in the exchange of valuable articles for currency. However, the owner often receives significantly less than the value of the article from such vendors, and furthermore, particularly in the case of wholesalers, the owner must wait for the wholesaler to sell the article. Accordingly, an improved system and method for exchanging such articles for funds may be beneficial.

### SUMMARY

Certain embodiments of the present invention may provide solutions to the problems and needs in the art that have not yet been fully identified, appreciated, or solved by current article exchange technologies. For example, some embodiments of the present invention analyze materials contained in articles and exchange funds for the articles based on a value of the materials in the articles.

In one embodiment, an apparatus includes an elemental analysis system configured to determine a material composition of an article and a scale configured to determine a weight of the article. The apparatus also includes a computing system configured to control operations of the apparatus. The computing system is configured to obtain the material composition of the article from the elemental analysis system and the weight of the article from the scale. The computing system is also configured to obtain a value of each element in the article from a data source and determine a total value of the article using the material composition of the article and the weight of the article. The computing system is further configured to reduce the total value of the article by an amount and offer the reduced value to a user via a display screen.

In another embodiment, an apparatus includes an elemental analysis system configured to determine a material composition of an article and a scale configured to weigh the article. The apparatus also includes a computing system configured to determine a value to offer a user for the article, taking into account the weight of the article and the material composition of the article. The apparatus further includes a printer configured to print user information on the article. The apparatus is configured to individually package the article in a packaging container.

In yet another embodiment, a method includes determining, by an article valuation and exchange system, a material composition and weight of an article and determining, by the system, a value of each element in the article. The method also includes calculating, by the system, an amount to offer a user based on the material composition, the weight, the value of each element in the article, and a percentage to reduce the amount of the offer by. The method further includes displaying the reduced amount of the offer, by the system, to the user.

### BRIEF DESCRIPTION OF THE DRAWINGS

In order that the advantages of certain embodiments of the invention will be readily understood, a more particular description of the invention briefly described above will be rendered by reference to specific embodiments that are illustrated in the appended drawings. While it should be understood that these drawings depict only typical embodiments of the invention and are not therefore to be considered to be limiting of its scope, the invention will be described and explained with additional specificity and detail through the use of the accompanying drawings, in which:

FIG. 1 is a front view of a system for exchanging articles for funds, according to an embodiment of the present invention.

FIG. 2 is a front view of a deposit bay, according to an embodiment of the present invention.

FIG. 3A is a side internal view of a system for exchanging articles for funds, according to an embodiment of the present invention.

FIG. 3B is a side internal view of the deposit bay and storage compartment of FIG. 3A with the scale in an elevated position, according to an embodiment of the present invention.

FIG. 4A is a side view of a storage compartment, according to an embodiment of the present invention.

FIG. 4B is a top view of the storage compartment of FIG. 4A, according to an embodiment of the present invention.

FIG. 5 is a side internal view of a system for exchanging articles for funds with an alternative article delivery configuration, according to an embodiment of the present invention.

FIG. 6 is a side internal view of a system for exchanging articles for funds with an individual article packaging configuration, according to an embodiment of the present invention.

FIGS. 7A and 7B are a flowchart illustrating a process for exchanging articles for funds, according to an embodiment of the present invention.

FIG. 8 is a block diagram of a computing system configured to facilitate the exchange of articles for funds, according to an embodiment of the present invention.

### DETAILED DESCRIPTION OF THE EMBODIMENTS

Some embodiments of the present invention pertain to an article analysis and exchange system that is configured to accept an article, such as jewelry or other articles having valuable materials, and analyze the composition of the article via one or more elemental analysis technologies, such as X-ray fluorescence, spectroscopy, or any other suitable elemental analysis technology. The system may also be configured to verify the identity of the user using a card reader, a thumbprint scanner, a retinal scanner, DNA sampling technology, a camera, and/or any other suitable identification system. Based on the outcome of the elemental analysis, the system may then check the value of the detected material(s), weigh the article, and offer an amount of money to the user based on the composition of the article and the material(s) therein. The current value may be checked for a given commodity, such as gold, silver, platinum, palladium, rare Earth metals, or any other material, in real time, or values may be obtained periodically, such as hourly, daily, weekly, etc. The value data may be obtained via any suitable network or communication mechanism, such as an Intranet, the Internet, a connection to a main office, etc.

The user may accept or reject the offer in some embodiments. If the offer is rejected, the article is returned to the user. If the offer is accepted, money may be physically dispensed to the user or electronically transferred to an account designated by the user. The article may then be stored in a compartment to be reported to the police and held for a state-mandated wait period. An employee of the organization that owns the system may then either physically remove the article and create an additional description or view the article online using a camera and generate the description from the image. In some embodiments, an image of the article may be captured by the system prior to being placed in the compartment. The article may then be reported to the police either by the employee or automatically by the system. In some embodiments, the system may be part of or otherwise associated with a physical bank location, a jewelry store, or any other organization that is accustomed to dealing with large amounts of money and/or valuables.

In some embodiments, it may be possible for a user to deposit multiple articles into the deposit bay. For instance, a user may choose to deposit a gold chain and two gold bracelets. The system may then analyze all three of these articles sequentially or simultaneously and determine the collective material composition of these articles. If the user accepts the transaction, the articles may be individually packaged, stored in the same package, or processed/stored in any desired way using a mechanical arm or claw, a conveyor, or any other suitable mechanism capable of parsing out and processing the articles.

In some embodiments, the elemental analysis equipment can only scan one article at a time, or only one article per emitter/detector pair. In such embodiments, the system may include multiple emitters/detectors and/or be configured to rotate the articles so they can be scanned. This can be accomplished via a turntable, a rotating scale, a robotic arm, or any other desired mechanism configured to move/position the articles for scanning. In some embodiments, the elemental analysis equipment may be configured to detect where the articles are using lasers, radar, sonar, or any other suitable technology and position the emitter/detector to scan each article. In certain embodiments, the system may be configured to scan all articles simultaneously or sequentially without rotating/positioning the articles. In some embodiments, the system may detect the dimensions of an article and sweep over all areas of the article in order to determine the composition of the entire article. In certain embodiments, the system may be configured to turn the article over using a robotic arm or other equipment configured to move articles such that all sides of the article may be analyzed.

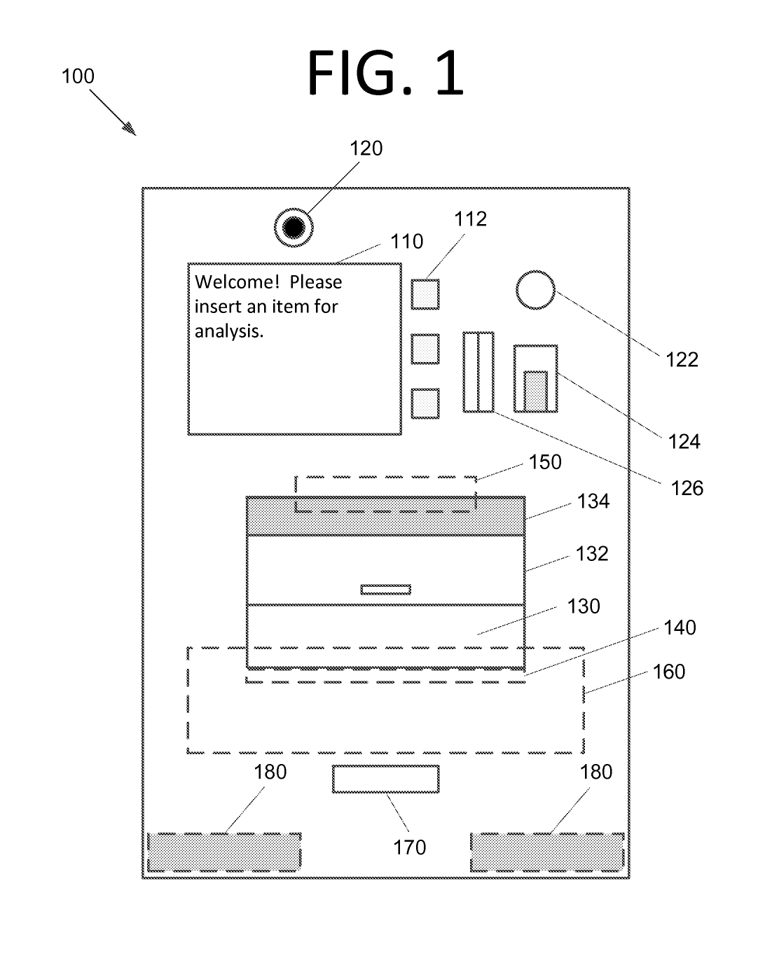

FIG. 1 is a front view of a system 100 for exchanging articles for funds, according to an embodiment of the present invention. System 100 includes a display screen 110 that is configured to display information to, and interact with, a user. A series of buttons 112 allow the user to interact with and respond to the information and prompts provided on display screen 110. However, in some embodiments, in addition to or in lieu of buttons 112, display screen 110 may include a haptic (i.e., touch sensitive) interface enabling the user to interact with display screen 110. Furthermore, in some embodiments, a separate keypad or keyboard (not shown) may be included.

A camera 120 is configured to capture an image of the user, a retinal scanner 122 is configured to capture a retinal image of the user, a fingerprint scanner 124 is configured to capture a fingerprint of the user, and a card reader 126 is configured to enable the user to swipe a credit card, driver's license, passport, or any other suitable form of identification. This information may then be stored by system 100 and/or transmitted to an external system to store information pertaining to the identity of the user. This information may be used later by the police or other authorities to track the user down in the event that the article was stolen, or the user is otherwise not the rightful owner of the article. Card reader 126 may also be used to record an account number from a debit card or credit card to which money for the article may be credited.

A deposit bay 130 is configured to receive the article from the user. The user may then slide an external door 132 to a closed position, or external door 132 may close automatically, which may trigger a signal from one or more sensors (not shown) indicating that external door 132 is closed and the article is ready for analysis. A scale 140 at the base of deposit bay 130 may confirm that an article has been placed in deposit bay 130 prior to commencing material analysis.

Certain elemental analysis techniques may create radiation that may potentially be harmful to the user. For instance, x-ray fluorescence analyzers emit x-rays in order to determine elements contained within an article. Accordingly, in this embodiment, a shielding door 134 including lead and/or other shielding materials may be closed before analysis of the article occurs. Deposit bay 130 may also be lined, or otherwise surrounded with, shielding material.

Elemental analysis system 150 then ascertains the elemental composition of the article. For instance, elemental analysis system 150 may determine that a gold chain is 40% gold and 60% nickel. A computing system (not shown) of system 100 may either obtain current material values from the Internet or use previously stored material values to determine an amount to offer to the user, which is then displayed on display screen 110. For example, system 100 may be configured to offer the user 70% of the total value of the article, or any other desired amount. Furthermore, in some embodiments, users may be offered a different percentage for different materials. This may encourage users to exchange articles that are more highly desirable.

In some embodiments, system 100 may offer different percentages based on a success rate and/or failure rate of previous transactions. These percentage scales may be the same or different for various materials. For instance, if system 100 was configured to offer 70% of the value of the gram or ounce weight of gold, and a percentage of users accepting gold transactions falls below a certain amount, the percentage of the value of gold that is offered may be increased. This percentage of most recent users may be determined based on a total number of transactions, a number of transactions in a certain most recent period of time (last day, week, month, etc.), a static number of most recent transactions (last 10, last 50, last N transactions, etc.), or in any other desired way.

For instance, if the percentage of users accepting gold transactions drops below 50%, the amount offered may be increased to 75% to attempt to increase the percentage of transactions that are accepted. If the accepted transaction percentage continues to drop, or remains below 50% for a certain number of transactions, the amount offered may be increased further. System 100 may set a cap on the maximum amount and/or minimum amount of the value offered, and this may vary from one material to another. For example, system 100 may be configured to offer no more than 90% of the value of gold and no less than 50% of its value.

The percentage by which the offer amount is increased may also be based on the percentage of successful transactions. For instance, if the successful transaction percentage is 25-50%, the amount offered may be increased by 5%. If the successful transaction percentage is 0-25%, the amount offered may be increased by 10%.

Similarly, if a relatively high percentage of transactions are being accepted, it is possible that users would accept a lower amount, and the percentage offered for a given material may be decreased. For instance, if 90-100% of users are accepting transactions, the amount offered may be decreased by 5%. Furthermore, in embodiments that are configured to both increase and decrease amounts offered based on successful transactions and/or percentages thereof, the increase and decrease rates may be different. In certain embodiments, the increase/decrease may be triggered based on the last N transactions all being accepted or all being rejected. Furthermore, any combination of these approaches for increasing/decreasing the amount offered may be employed in certain embodiments.

Through the approaches described above, and/or various combinations thereof, a dynamic valuation may be realized that adapts to various acceptance rates for different materials. For instance, users with platinum articles may want a higher offer amount relative to material value than users with silver articles. Such approaches may increase the revenue that can be derived from system 100.

The user may then accept or reject the offer. If the offer is accepted, the article is dropped, slid, conveyed, or otherwise moved into storage compartment 160. In some embodiments, the article may be stored in its own compartment, or may be placed in a common compartment with other articles. In certain embodiments, articles may be separately packaged prior to storage. The user is then either paid cash through vending slot 170 or funds are electronically transferred to the user's desired bank account or credit card. The latter may be particularly desirable where the article has a high value, or if system 100 does not have sufficient cash stored in money storage (not shown) to make the full payment.

System 100 may also be configured to limit the amount that the user is able to take in cash. In certain embodiments, the user may be able to select a certain amount to receive in cash and certain amount(s) to deposit to one or more accounts, credit cards, etc. For large transactions over a certain amount, such as those over $10,000, system 100 may be configured to automatically report the transaction to the relevant governmental entities, such as the Internal Revenue Service (IRS), the police, etc. Many embodiments may be configured to take into account, and be fully compliant with, state and federal laws.

At any time during the process, in some embodiments, an image of the article may be taken by an internal camera (not shown). At the time the user accepts the transaction, or at any time thereafter, the image of the article may be transmitted to an employee or other individual so that he or she can enter a description for police. Alternatively, the employee or other individual may physically inspect the article by removing it from system 100. A description may then be created and either transmitted to the police by the employee or other individual or automatically transmitted to the police by system 100 via its computing system. Articles may be held for a predetermined hold period, and various identity information collected by system 100 may be stored in its computing system and/or transmitted to the police. The articles may either be kept within system 100 or moved to another storage location. Once the waiting period elapses, the articles may be sent to a smelter to be rendered into their constituent elements.

In some embodiments, system 100 may be approximately the size of a conventional stand-alone automated teller machine (“ATM”), but the system can have any desired shape, size, and weight as a matter of design choice. In FIG. 1, the weight of system 100 is increased by weights 180 that make system 100 more difficult to steal. System 100 may also be physically affixed to the ground or the floor, to a wall of a location, or to any other desired structure or surface, which may further increase the difficulty of stealing system 100.

It should be noted that the doors, extending members, and other moving components discussed herein may be moved by actuators, motors, hydraulics, or any other desired mechanism for driving motion. Further, certain of these moving components may be operated manually in some embodiments. The precise mechanisms used to facilitate this motion are a matter of design choice and would be understood by one of ordinary skill in the art.

As discussed above, some embodiments may use x-ray fluorescence to determine the elemental composition of articles. When exposed to x-rays, gamma rays, or other high energy photons, ionization of the atoms making up the material may take place. As used herein, “x-ray fluorescence” may utilize any higher energy photon emission type. However, it should be noted that use of higher energy photons may require significant shielding.

When exposed to radiation with an energy greater than its ionization potential, tightly held electrons may be expelled from inner orbitals of the atoms. This makes the electron structure of the atom unstable, and electrons in higher orbitals will fill this “hole” in the lower orbital, releasing a photon with energy equal to the energy difference of the two orbitals involved. The energies released in this manner are characteristic of the atoms that are present, and can be used to determine the elemental composition. Based on the weight of the article and the composition of the material, the respective masses of each element can be determined.

Certain embodiments may use Raman spectroscopy to determine the elements and/or compounds in the article. Raman spectroscopy measures vibrational modes, rotational modes, and/or other low frequency modes to identify the molecules and compounds that are present. Raman spectroscopy relies on, and measures, Raman scattering of monochromatic light, usually from a laser in the visible, near infrared, or near ultraviolet range. Another technique that may be applied in some embodiments is Fourier transform infrared spectroscopy (FTIR), which utilizes the infrared region of the electromagnetic spectrum. This approach may be complementary to Raman spectroscopy in some embodiments.

In certain embodiments, multiple elemental composition approaches may be employed in the same system, either simultaneously or sequentially. Further, in some embodiments, one technique may be used initially and one or more other techniques may be used based on material composition. Furthermore, a person of ordinary skill in the art will readily appreciate that any technique that identifies the elements and/or compounds in an article may be used in addition to, or in lieu of, the approaches disclosed above, or combinations thereof.

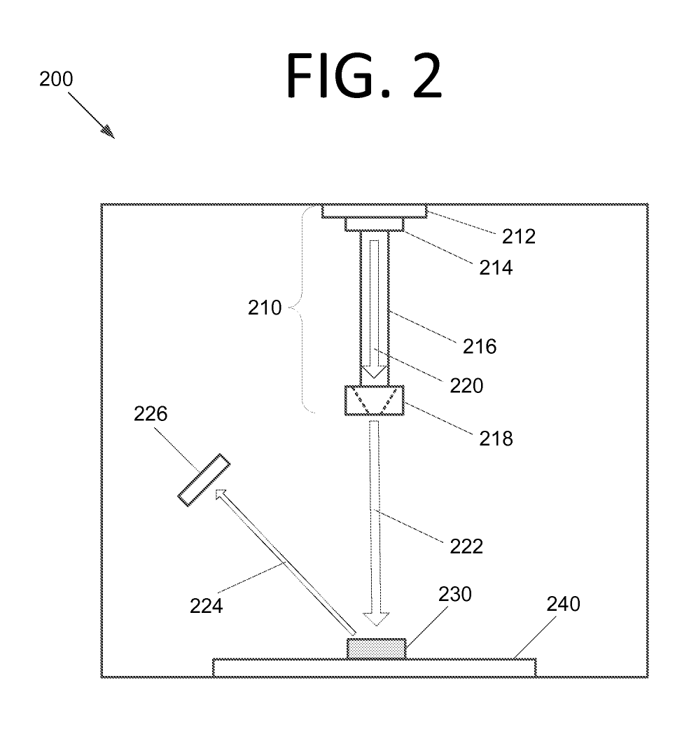

FIG. 2 is a front view of a deposit bay 200, according to an embodiment of the present invention. The doors of deposit bay 200 are not shown in FIG. 2 in order to better illustrate its components. Deposit bay 200 includes an x-ray emitter 210, an emission detector 226, and a scale 240. Article 230 rests upon scale 240. A computing system (not shown) is configured to control and interface with x-ray emitter 210, x-ray detector 226, and scale 240.

X-ray emitter 210 includes a base 212 attaching x-ray emitter 210 to the top of deposit bay 200. However, the location of the elemental analysis systems in various embodiments is a matter of design choice. X-ray emitter 210 also includes an x-ray generator 214 that is configured to generate unfocused x-rays 220. However, in some embodiments, other high energy photons, such as gamma rays, may be generated in addition to or in lieu of x-rays. Unfocused x-rays 220 then travel down channel 216 to focuser 218, which focuses unfocused x-rays 220 into focused x-rays 222.

Focused x-rays 222 contact article 230 and cause photon emissions 224 from the material(s) in article 230. The photon emissions contact emission detector 226, and the composition of article 230 may be determined based on the physics of x-ray fluorescence. The computing system determines the composition of the elements in article 230 and receives the weight of article 230 from scale 240. By multiplying the percentage of an element by the weight of article 230, the amount of that element present in article 230 may be determined. For instance, if article 230 weighs 10 ounces and is 70% gold and 30% nickel, it follows that article 230 contains 7 ounces of gold and 3 ounces of nickel. It should be noted that embodiments using spectroscopy or other elemental analysis technologies may have different components and configurations as required by those technologies.

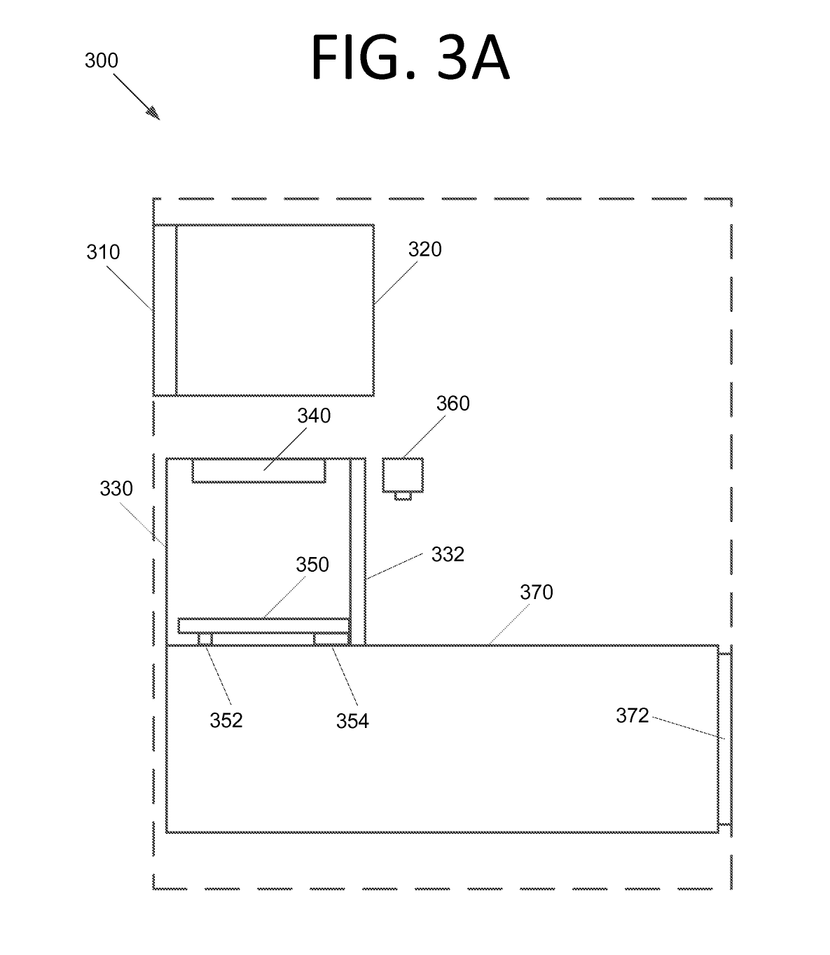

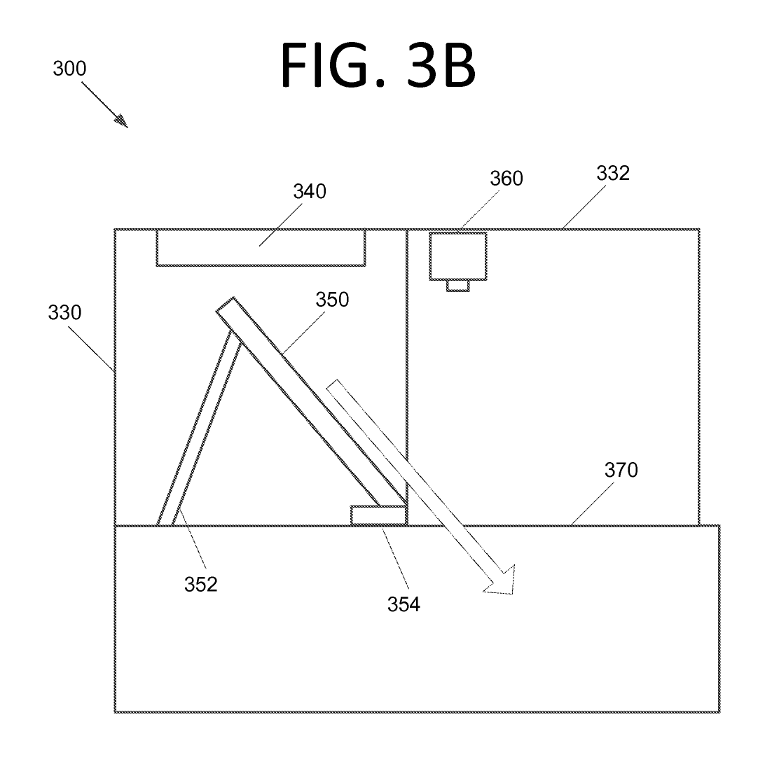

FIG. 3A is a side internal view of a system 300 for exchanging articles for funds, according to an embodiment of the present invention. System 300 includes a display screen 310 that is configured to display information to, and interact with, a user. A computing system 320 is configured to cause display screen 310 to display various information to the user and to process user responses. Computing system 320 is also configured to control the various operations of system 300.

A deposit bay 330 is configured to receive an article from the user. Deposit bay 330 includes a door 332 that allows articles to be moved from deposit bay 330 into storage compartment 370. Elemental analysis system 340 is configured to ascertain the elemental composition of the article.

A scale 350 at the base of deposit bay 330 is configured to weigh the article. Scale 350 is attached to a base of deposit bay 330 via an extending member 352 and a hinge 354. A camera 360 is configured to capture an image of the article as it is moved into storage compartment 370. However, in some embodiments, the camera may be located in deposit bay 330, storage compartment 370, or any other desired location. In certain embodiments, multiple cameras may be used. Storage compartment 370 also has a door 372 that facilitates access to the contents of storage compartment 370. In certain embodiments, storage compartment 370 may be removable from system 300 via door 372, or may slide out from door 372 in a manner similar to a drawer. Door 372 may have a security mechanism, such as a lock, to deter access by unauthorized individuals.

FIG. 3B is a side internal view of deposit bay 330 and storage compartment 370 of FIG. 3A with scale 350 in an elevated position, according to an embodiment of the present invention. Door 332 is shown swung outward into an open position in this embodiment, but any other configuration for opening door 332 may be used. For instance, by way of non-limiting example, door 332 may move up or down vertically, or a slot in a wall of deposit bay 330 may open.

In this embodiment, when the user accepts a transaction, scale 350 pivots about hinge 354 and is elevated by extending member 352. In some embodiments, extending member 352 may be a hydraulic piston, a rod driven by an actuator, or any other extensible mechanism that would be understood by one of ordinary skill in the art. The article then slides into storage compartment 370 and may be photographed by camera 360 as it passes. To prevent damage to the article, scale 350 and/or storage compartment 370 may be lined with a cushioning material, such as fabric, rubber, or any other suitably soft material.

It should be appreciated that in other embodiments, different mechanisms for conveying the article into storage compartment 370 may be used. For instance, some embodiments may use a trapdoor within scale 350, or may use a conveyor (not shown) configured to move articles from scale 350 into storage compartment 370. Any suitable conveying mechanism, or combination of conveying mechanisms, may be used.

In some embodiments, in lieu of a storage container, articles may be individually packaged or stored in separate containers. In certain embodiments, multiple compartments may exist within storage compartment 370, and articles may be stored individually or grouped into a single compartment with other similar articles. The compartments may have any desired size or shape as a matter of design choice.

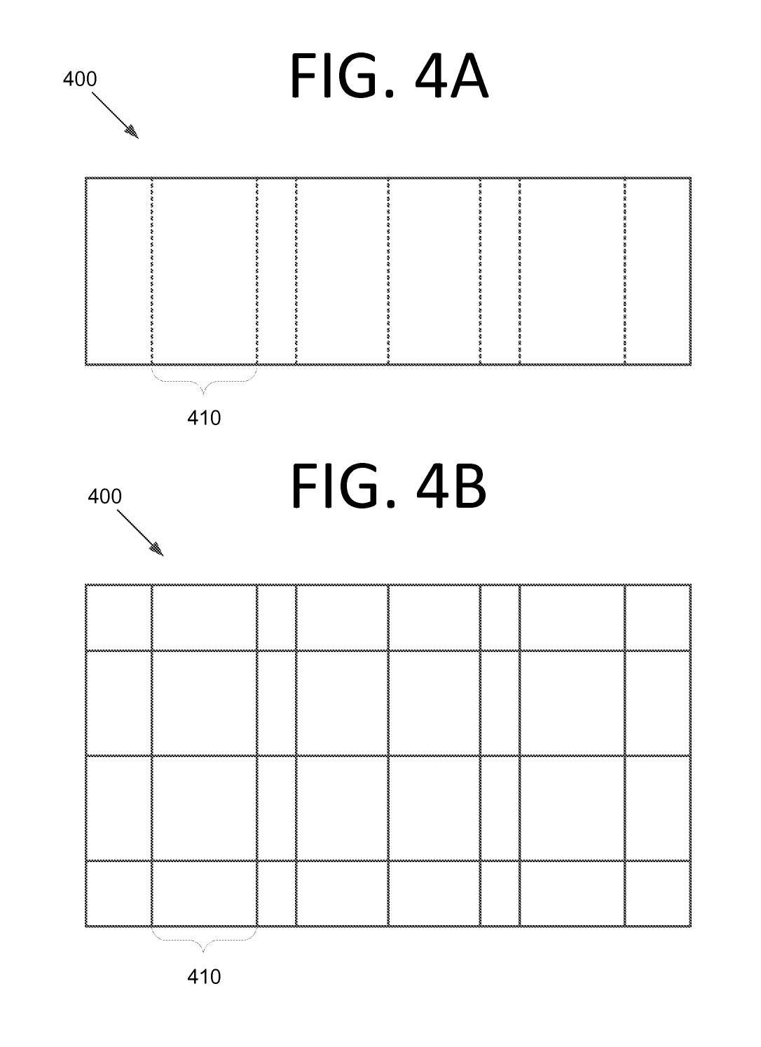

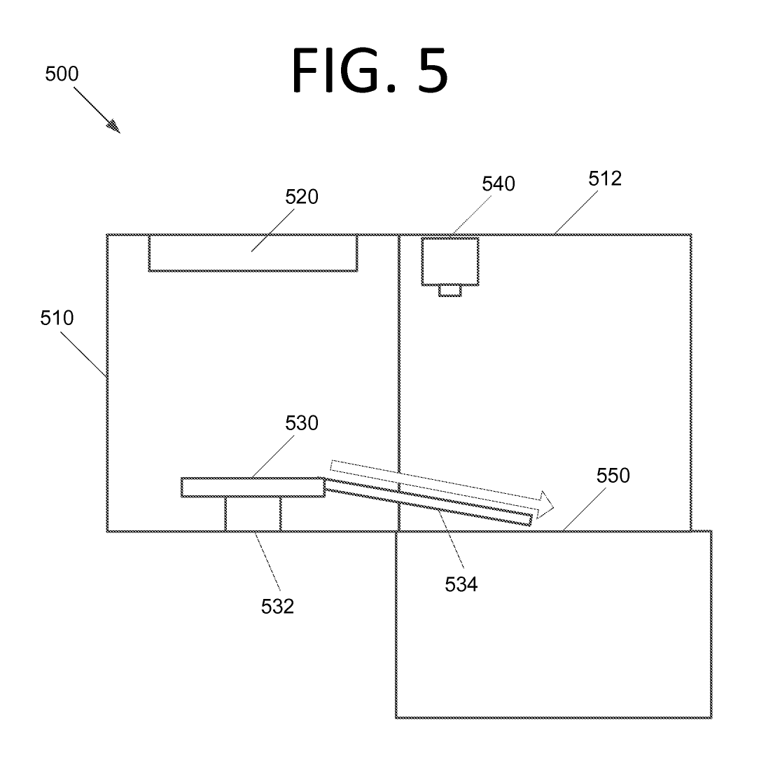

Some jurisdictions require segregation of valuable articles by law. One embodiment of such a configuration is shown in FIGS. 4A and 4B. FIG. 4A is a side view of a storage compartment 400 and FIG. 4B is a top view of storage compartment 400, according to an embodiment of the present invention. In FIGS. 4A and 4B, individual compartments 410 are configured to store articles. Compartments 410 have different sizes in this embodiment. However, compartments may be the same size in certain embodiments, and may have any desired size.

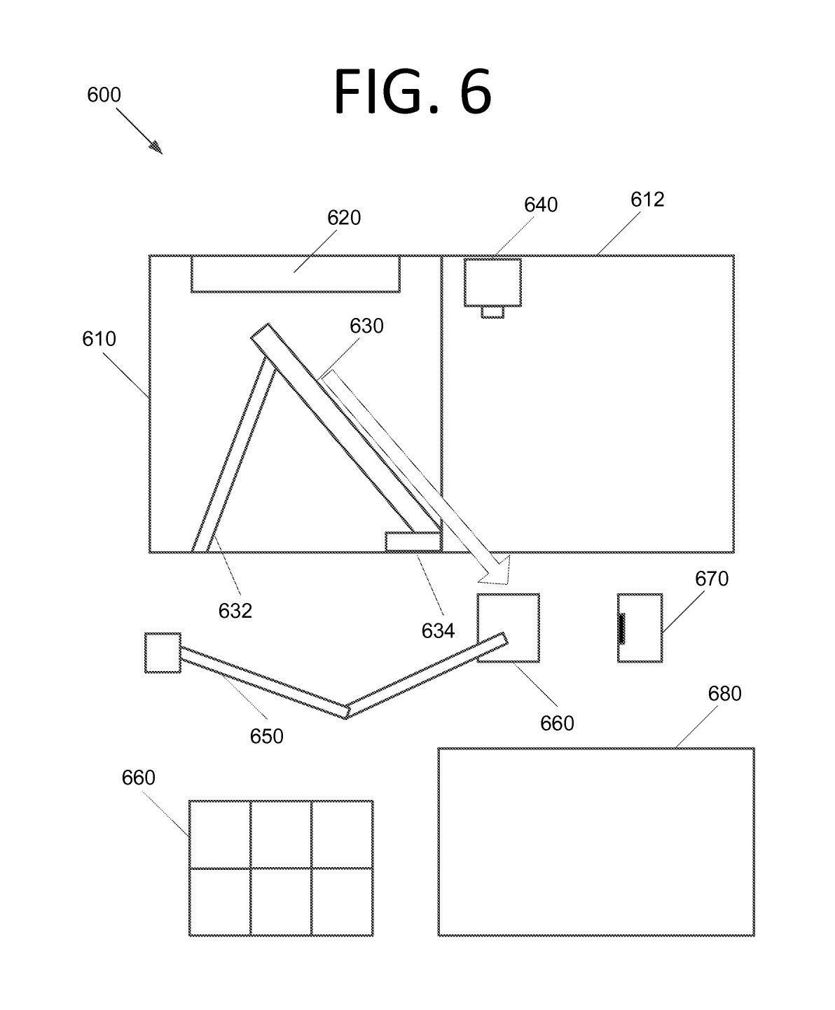

FIG. 5 is a side internal view of a system 500 for exchanging articles for funds with an alternative article delivery configuration, according to an embodiment of the present invention. System 500 includes a deposit bay 510 with an elemental analysis system 520. In FIG. 5, door 512 of deposit bay 510 is shown in an open position. In this embodiment, when the user accepts a transaction, a scale 530 pivots about a base 532 and the article may be moved to an extending member 534 by a conveyor (not shown). Alternatively, base 532 may be configured to tilt so the article slides onto extending member 534.

Extending member 534 is configured to be extended and retracted, in association with rotating base 532, such that articles may be delivered to a desired compartment or location within storage compartment 550. The article then slides into storage compartment 550 and may be photographed by camera 540 as it passes. Such a configuration may be particularly suitable for delivering articles to individual storage compartments.

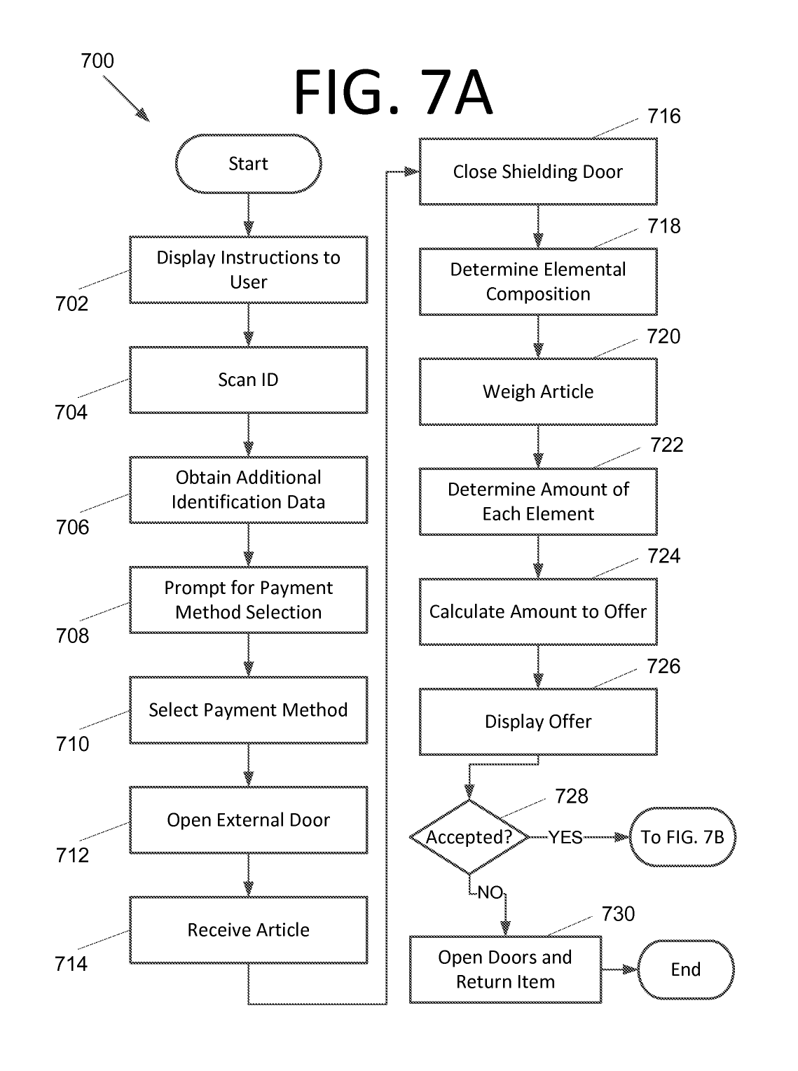

Some embodiments are configured to identify and bag, box, or otherwise place articles in individual receptacles. This is required for each transaction for police reporting in most states. In such embodiments, articles are kept separately and held until the holding period elapses. For instance, Florida has a required holding period of 14 days. The owner's information, a bar code, or any other desired information may be printed on the bag, box, receptacle, or other packaging container. Such an embodiment is shown in FIG. 6. However, in certain embodiments, this information may be manually written on the side of individual containers by an employee.

FIG. 6 is a side internal view of a system 600 for exchanging articles for funds with an individual article packaging configuration, according to an embodiment of the present invention. System 600 includes a deposit bay 610 with an elemental analysis system 620. In FIG. 6, door 612 of deposit bay 610 is shown in an open position.

A scale 630 at the base of deposit bay 610 is configured to weigh the article. Scale 630 is attached to a base of deposit bay 630 via an extending member 632 and a hinge 634. A camera 640 is configured to capture an image of the article as it is moved into storage compartment 680.

A robotic arm 650 is configured to retrieve and move individual boxes 660. However, in certain embodiments, plastic bags or any other desired container may be used. Robotic arm 650 may be configured to extend, retract, and bend via a plurality of joints and actuators, hydraulics, etc. In certain embodiments, robotic arm 650 may be configured to close boxes or bags, or to place a lid on boxes or other containers. However, any another suitable mechanism may be configured to do so. In some embodiments, boxes of different sizes may be provided, and selected by system 600 depending on a size of the article, which may be determined by laser scanning (not shown) or any other desired mechanism. In some embodiments, boxes 660 may be designed so that they are stackable and stored in system 660 like Styrofoam™ cups, which may save space. In such a configuration, the bottom of each box 660 may be somewhat smaller than the top. In certain embodiments, the top may be configured to accept a plastic lid. In certain embodiments, box 660 may be a light cardboard coated with Styrofoam™. However, any desired material or combination of materials may be used.

In this embodiment, robotic arm 650 is configured to move box 660 into a position to receive the article, as shown. Robotic arm 650 then moves box 660 to printer 670 to have owner information, a bar code, and any other desired information printed thereon. In certain embodiments, such information may be printed on box 660 prior to receiving the article, or prior to being picked up by robotic arm 650. Robotic arm 650 then places box 660 into storage container 680.

In some embodiments, such as that illustrated in FIG. 6, articles are moved to an individual container or plastic numbered sealed bag. A strong sealed plastic bag may serve particularly well for segregation of each item with imprinted identification information. However, this may add complexity to the interior design of the system. In some embodiments, a scanning bay is used that is suspended above the scale so that the scale cannot be triggered until after the article is analyzed and determined to be something of value. A mechanism in the scanning bay may then lower the article onto the calibrated scale. In certain embodiments, the article may be placed into a container or bag prior to scanning. The location of the scale and the elemental analysis system, and the order of weighing and analysis of the article, are a matter of design choice. In some embodiments, weighing and elemental analysis of the article may occur simultaneously or substantially simultaneously.

In some embodiments, the scanning bay that accepts the article for scanning may rotate 180° from left-to-right or right-to-left, and then downward 90°, dumping the article into a boxing system that had first printed identification information on a flat surface of the box and places a top on the box, or closes it, before depositing the box into a general collection area, such as a storage container. Per the above, the identification may include a barcode containing owner information that may be scanned later. A daily or other periodic report may be sent to an email account designated by the owner of the system via the Internet and may contain all of the information concerning the seller and the barcode identification number. Software can be used to generate a barcode or other form of identification. The software for the system may also provide encryption.

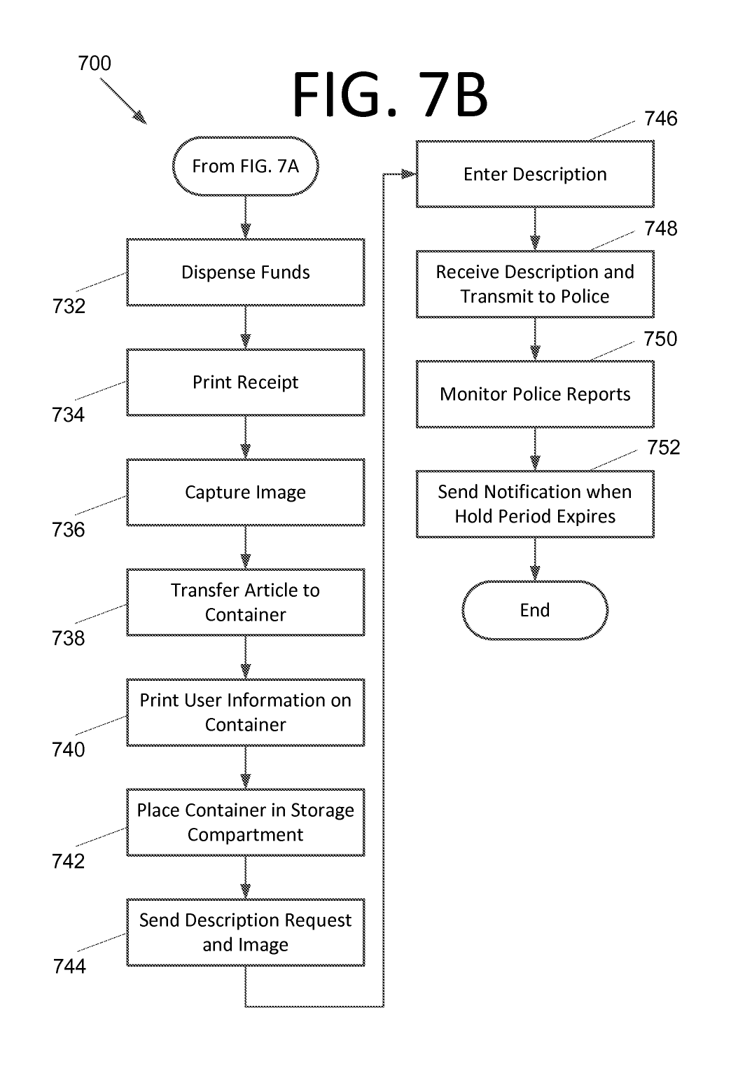

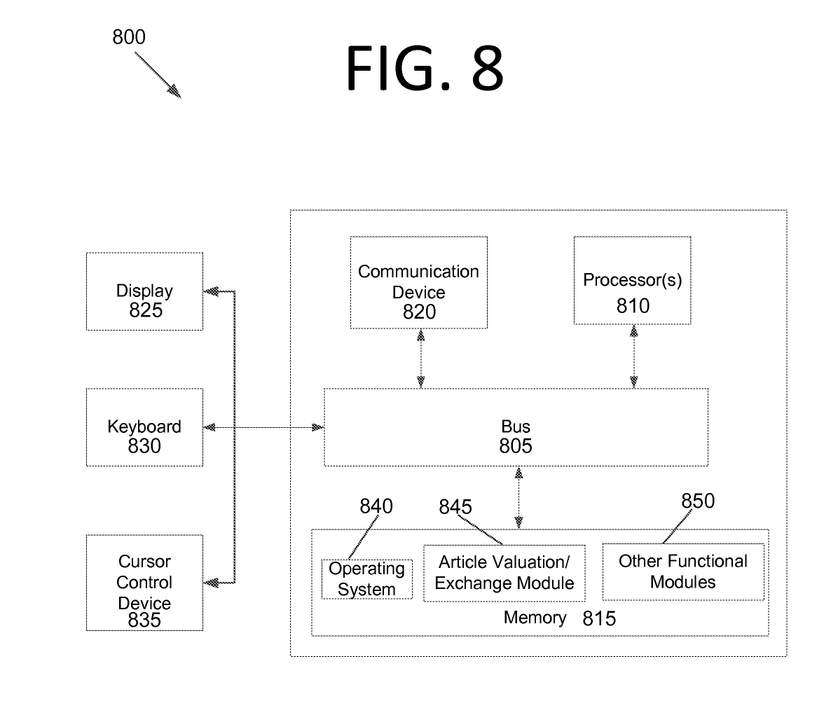

FIGS. 7A and 7B are a flowchart 700 illustrating a process for exchanging articles for funds, according to an embodiment of the present invention. In some embodiments, the process may be implemented by system 100 of FIG. 1, which may include computing system 800 of FIG. 8. The process begins with displaying instructions to the user for using the system at 702. The user then has his or her driver's license, passport, or other identification scanned and read at 704. This may be accomplished by a card reader, an optical scanner, or any other suitable device. The system obtains other user identification data, such as an optical scan, a fingerprint, a photograph, and/or a video of the user at 706. The system prompts the user whether cash is desired or whether to transfer money to a bank account or apply it towards a credit card at 708. The user then selects the desired payment by selecting cash, swiping a credit or debit card, or entering an account number at 710.

An external door to the deposit bay or scanning bay, depending on the configuration, is then opened at 712. This may be opened by the user or opened automatically, depending on the embodiment. The user then places the article into the bay at 714.

Once the article has been placed in the bay, a shielding door closes at 716 to protect the user from radiation. The system then scans the article to determine its elemental composition at 718 and weighs the article at 720. The system looks up the value of the elements and determines the amount of each element in the article at 722. In some embodiments, the current, near-real time or real time value of the elements may be determined by accessing a commodity data source via the Internet. The data may be parsed from HTML or other code on a website, obtained directly through an Internet connection, or via any suitable means. If no Internet connection is available, such embodiments may default to looking up values in a table containing the last known values. The system then calculates an amount to offer the user based on the elemental composition at 724. The amount may be based on the value and weight of each element reduced by a certain amount (e.g., 10%) to compensate the owner of the system for the transaction and make a profit from the system. In some embodiments, the system may only detect certain elements, and/or may only offer users a price for certain elements. For instance, the system may offer users money only for precious metals and rare Earth metals.

The system then displays an offer to the user at 726. If the user rejects the offer at 728, the shielding door and external door are opened at 730, the user may retrieve the article, and the process ends. However, if the user accepts the offer at 728, cash is dispensed to the user or transferred to the desired account at 732. A receipt is then printed for the user at 734. An image of the article is captured by a camera at 736.

The article is then transferred into an individual container at 738, and information pertaining to the user is printed on the container at 740. The container storing the article is then placed in a storage compartment at 742. The system then sends a request for a description of the article and the image of the article to an employee associated with the system at 744. The employee then enters the description at 746. The system receives the description and transmits the description, image, and user information to police at 748. The system then periodically monitors police reports at 750 and compares them to the article description to determine whether the article was stolen. Police reports are generally uploaded to the Internet daily, and are typically written such that they may be read by an average reader at the 3^{rd} grade level. Once the state-mandated hold period expires, the system transmits a notification to the employee associated with the system at 752. The article, or a batch of articles, may then be sent to a smelter for processing and separation into their constituent materials.

A table of the timing of events for a transaction in an embodiment is provided below in Table 1.

TABLE 1
TIMING OF EVENTS FOR TRANSACTION

| EVENT | TIME (sec) |
|---|---|
| User reads instructions | 90 |
| User scans driver's license | 60 |
| User opens external door | 4 |
| User deposits article in bay | 4 |
| System scans article | 10 |
| System weighs article | 4 |
| System calculates value and makes offer | 2 |
| User reads and signs offer | 45 |
| System acquires thumbprint and photo | 10 |
| System dispenses money | 3 |
| System prints receipt | 2 |
| System moves article into individual | 7 |
| container and stores article | |
| TOTAL TIME | 241 |

In this example, the total time for an average transaction is estimated to be 241 seconds, or four minutes and one second. This means that in a seven hour day, the maximum number of transactions that could be processed at this rate is 104.5643. However, in some embodiments, the system does not need to be inactivated and can remain active 24 hours per day, particularly where the system is accessible outside of a location.

FIG. 8 is a block diagram of a computing system 800 configured to facilitate the exchange of articles for funds, according to an embodiment of the present invention. Computing system 800 includes a bus 805 or other communication mechanism for communicating information, and processor(s) 810 coupled to bus 805 for processing information. Processor(s) 810 may be any type of general or specific purpose processor, including a central processing unit (“CPU”) or application specific integrated circuit (“ASIC”). Processor(s) 810 may also have multiple processing cores, and at least some of the cores may be configured to perform specific functions. Computing system 800 further includes a memory 815 for storing information and instructions to be executed by processor(s) 810. Memory 815 can be comprised of any combination of random access memory (“RAM”), read only memory (“ROM”), flash memory, cache, static storage such as a magnetic or optical disk, or any other types of non-transitory computer-readable media or combinations thereof. Additionally, computing system 800 includes a communication device 820, such as a transceiver, to wirelessly provide access to a communications network.

Non-transitory computer-readable media may be any available media that can be accessed by processor(s) 810 and may include both volatile and non-volatile media, removable and non-removable media, and communication media. Communication media may include computer-readable instructions, data structures, program modules or other data in a modulated data signal such as a carrier wave or other transport mechanism and includes any information delivery media.

Processor(s) 810 are further coupled via bus 805 to a display 825, such as a Liquid Crystal Display (“LCD”), for displaying information to a user. A keyboard 830 and a cursor control device 835, such as a computer mouse, are further coupled to bus 805 to enable a user to interface with computing system 800. However, in certain embodiments, a physical keyboard and mouse may not be present, and the user may interact with the device solely through display 825 and/or a touchpad (not shown). Any type and combination of input devices may be used as a matter of design choice.

In one embodiment, memory 815 stores software modules that provide functionality when executed by processor(s) 810. The modules include an operating system 840 for computing system 800. The modules further include an article valuation/exchange module 845 that is configured to facilitate transactions exchanging articles for funds. For instance, article valuation/exchange module may control various components of a system such as system 100 of FIG. 1. Computing system 800 may include one or more additional functional modules 850 that include additional functionality.

One skilled in the art will appreciate that a “system” could be embodied as a personal computer, a server, a console, a personal digital assistant (“PDA”), a cell phone, a tablet computing device, or any other suitable computing device, or combination of devices. Presenting the above-described functions as being performed by a “system” is not intended to limit the scope of the present invention in any way, but is intended to provide one example of many embodiments of the present invention. Indeed, methods, systems and apparatuses disclosed herein may be implemented in localized and distributed forms consistent with computing technology, including cloud computing systems.

It should be noted that some of the system features described in this specification have been presented as modules, in order to more particularly emphasize their implementation independence. For example, a module may be implemented as a hardware circuit comprising custom very large scale integration (“VLSI”) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, comprise one or more physical or logical blocks of computer instructions that may, for instance, be organized as an object, procedure, or function. Nevertheless, the executables of an identified module need not be physically located together, but may comprise disparate instructions stored in different locations which, when joined logically together, comprise the module and achieve the stated purpose for the module. Further, modules may be stored on a computer-readable medium, which may be, for instance, a hard disk drive, flash device, RAM, tape, or any other such medium used to store data.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

The process steps performed in FIGS. 7A and 7B may be performed by a computer program, encoding instructions for the nonlinear adaptive processor to perform at least the process described in FIGS. 7A and 7B, in accordance with embodiments of the present invention. The computer program may be embodied on a non-transitory computer-readable medium. The computer-readable medium may be, but is not limited to, a hard disk drive, a flash device, a random access memory, a tape, or any other such medium used to store data. The computer program may include encoded instructions for controlling the nonlinear adaptive processor to implement the process described in FIGS. 7A and 7B, which may also be stored on the computer-readable medium.

The computer program can be implemented in hardware, software, or a hybrid implementation. The computer program can be composed of modules that are in operative communication with one another, and which are designed to pass information or instructions to display. The computer program can be configured to operate on a general purpose computer, or an ASIC.

It will be readily understood that the components of various embodiments of the present invention, as generally described and illustrated in the figures herein, may be arranged and designed in a wide variety of different configurations. Thus, the detailed description of the embodiments of the systems, apparatuses, methods, and computer programs of the present invention, as represented in the attached figures, is not intended to limit the scope of the invention as claimed, but is merely representative of selected embodiments of the invention.

The features, structures, or characteristics of the invention described throughout this specification may be combined in any suitable manner in one or more embodiments. For example, reference throughout this specification to “certain embodiments,” “some embodiments,” or similar language means that a particular feature, structure, or characteristic described in connection with the embodiment is included in at least one embodiment of the present invention. Thus, appearances of the phrases “in certain embodiments,” “in some embodiment,” “in other embodiments,” or similar language throughout this specification do not necessarily all refer to the same group of embodiments and the described features, structures, or characteristics may be combined in any suitable manner in one or more embodiments.

It should be noted that reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

1. An apparatus, comprising:
an elemental analysis system configured to determine a material composition of an article;
a scale configured to determine a weight of the article; and
a computing system configured to control operations of the apparatus, wherein
the computing system is configured to
obtain the material composition of the article from the elemental analysis system and the weight of the article from the scale,
obtain a value of each element in the article from a data source,
determine a total value of the article using the material composition of the article and the weight of the article,
reduce the total value of the article by an amount, and
offer the reduced value to a user via a display screen.

2. The apparatus of claim 1, further comprising:
a deposit bay configured to receive the article from the user, wherein the deposit bay comprises the elemental analysis system and the scale, and the deposit bay is configured to convey the article into a storage compartment.

3. The apparatus of claim 2, wherein the storage compartment comprises a plurality of individual compartments, and the computing system is configured to cause the deposit bay to place the article into its own separate compartment.

4. The apparatus of claim 2, wherein the deposit bay further comprises a shielding door configured to protect the user from radiation.

5. The apparatus of claim 2, wherein the deposit bay comprises or is surrounded by shielding material configured to contain radiation from the elemental analysis system.

6. The apparatus of claim 1, wherein the elemental analysis system is configured to use x-ray fluorescence, spectroscopy, or both.

7. The apparatus of claim 1, further comprising:
a storage compartment comprising a plurality of individual compartments, the storage compartment configured to store the article.

8. The apparatus of claim 1, further comprising:
a camera configured to capture an image of the article, wherein
the computing system is configured to transmit the captured image to an individual and to receive and store a description of the article.

9. The apparatus of claim 8, wherein the computing system is configured to transmit the image of the article, the description of the article, and information pertaining to the user to appropriate authorities.

10. The apparatus of claim 1, further comprising one or more of an external camera, a retinal scanner, a fingerprint scanner, and a card reader.

11. The apparatus of claim 1, wherein the computing system is configured to obtain the value of each element in the article from in real time from an Internet data source.

12. The apparatus of claim 1, wherein the apparatus is configured to individually package the article in a packaging container and print user information on the packaging container.

13. The apparatus of claim 12, further comprising:
a robotic arm configured to pick up the packaging container, receive the article in the packaging container, and place the packaging container in storage.

14. An apparatus, comprising:
an elemental analysis system configured to determine a material composition of an article;
a scale configured to weigh the article;
a computing system configured to determine a value to offer a user for the article, taking into account the weight of the article and the material composition of the article; and
a printer configured to print user information on the article, wherein
the apparatus is configured to individually package the article in a packaging container.

15. The apparatus of claim 14, wherein the apparatus is further configured to receive the article in the packaging container, place a lid on the packaging container, and place the lidded packaging container in a storage compartment.

16. A method, comprising:
determining, by an article valuation and exchange system, a material composition and weight of an article;
determining, by the system, a value of each element in the article;
calculating, by the system, an amount to offer a user based on the material composition, the weight, the value of each element in the article, and a percentage to reduce the amount of the offer by; and
displaying the reduced amount of the offer, by the system, to the user.

17. The method of claim 16, further comprising:
returning the article to the user, by the system, when the user rejects the offer; and
storing the article, by the system, and providing the user with payment for the article when the user accepts the offer.

18. The method of claim 16, further comprising:
prompting the user, by the system, whether the user wants to receive cash for the article, wants to transfer funds to one or more bank accounts and/or credit cards, or both; and
receiving and storing, by the system, the user's payment preferences.

19. The method of claim 16, further comprising:
obtaining, by the system, user identification data verifying an identity of a user;
capturing an image of the article, by the system; and
receiving and storing a description of the article, by the system.

20. The method of claim 18, further comprising:
sending, by the system, the image of the article, user identification data, and description of the article to appropriate authorities.

21. The method of claim 18, further comprising:
printing, by the system, at least some of the user identification data on a packaging container for the article.
